(19) United States
(12) Patent Application Publication
(10) Pub. No.: US 2025/0067551 A1
(43) Pub. Date: Feb. 27, 2025

(54) INTEGRATED ELECTRONIC SYSTEM FOR OPTICAL COHERENCE TOMOGRAPHY

(71) Applicant: Myriad Advanced Technologies LLC, Foothill Ranch, CA (US)

(72) Inventors: Muhammad Al-Qaisi, Irvine, CA (US); Kumara Ratnayake, Pierrefonds (CA); Amr Elbasiony, Andover, MA (US)

(21) Appl. No.: 18/814,367

(22) Filed: Aug. 23, 2024

Related U.S. Application Data
(60) Provisional application No. 63/534,554, filed on Aug. 24, 2023.

(51) Int. Cl. G01B 9/02; G01B 9/02091

(52) U.S. Cl. CPC G01B 9/02051; G01B 9/02089; G01B 9/02091

(57) ABSTRACT

The disclosed technology is directed to an integrated electronic system for OCT. In some examples, the integrated electronic system includes an integrated circuit that is configured to generate image data based on OCT interference signals for display. The integrated circuit includes an analog circuit, a core processing subsystem, and a backend processing subsystem. The analog circuit receives and digitizes the OCT interferences signals to generate digitized interferences signals. The core processing subsystem generates the image data based on the digitized interference signals. The backend processing subsystem receives and causes the image data for display to a user.

### CROSS-REFERENCE TO RELATED APPLICATIONS

This application claims benefit of U.S. Provisional Patent Application No. 63/534,554, filed Aug. 24, 2023, and titled “System on Chip for OCT systems.” The entire disclosure of each of the above items is hereby made part of this specification as if set forth fully herein and incorporated by reference for all purposes, for all that it contains.

Any and all applications for which a foreign or domestic priority claim is identified in the Application Data Sheet as filed with the present application are hereby incorporated by reference under 37 CFR 1.57 for all purposes and for all that they contain.

### TECHNICAL FIELD

The present disclosure relates to systems and techniques used for optical coherence tomography (OCT). More specifically, the present disclosure relates to electronic systems for realizing OCT related applications.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Optical coherence tomography (OCT) is a medical and biological imaging technology. OCT utilizes low-coherence interferometry to perform optical ranging within biological samples. OCT provides a unique tool that visualizes depth-resolved micron-level tissue features and structures.

### SUMMARY

The systems, methods, and devices described herein each have several aspects, no single one of which is solely responsible for its desirable attributes. Without limiting the scope of this disclosure, several non-limiting features will now be described briefly.

Optical coherence tomography (OCT) is a widely-used imaging technology for medical, metrology and industrial applications. Current OCT systems typically employ several discrete boards (e.g., printed circuit boards (PCBs)) and/or cards (e.g., data acquisition cards (DAQs)) deployed with associated optical or electrical components to fulfill various functionalities. For example, an OCT system may utilize one board to capture optical signals for converting to electrical signals, utilize another board to facilitate control on peripheral components (e.g., galvanometer scanners, protection circuitry, or the like), and utilize yet another board to facilitate control on laser modules. Additionally, the OCT system may employ a discrete card for linearizing, processing, and/or reconstructing image data based on digitized interference signals. The OCT system may further use a computer workstation, a laptop, and/or discrete graphics cards for displaying or rendering images to users based on the image data. Such unintegrated and fragmented implementations, however, may be deficient to meet increased demands on OCT systems at least regarding latency, resolution, signal bandwidth and/or data rates, and cost. For example, latency may be introduced by physical interconnections between different boards, the subsequent handshake, and/or other required communications. Signal bandwidth may be limited by signal traces, packaging of discrete chips, wires connecting discrete boards, and/or cards of the OCT system. As another example, noise may be injected to degrade qualities of signals during transmission over physical connections across boards.

The present disclosure implements an integrated electronic system (e.g., a system-on-a-chip (SoC)) that can advantageously overcome various of the technical challenges mentioned above, among other technical challenges. In some implementations, the integrated electronic system integrates at least some electronic subsystems for realizing OCT related applications within a single integrated circuit (IC). For example, instead of using various boards and/or cards for displaying OCT images, the integrated electronic system can process analog signals converted from optical signals (e.g., OCT interference signals), generate linearized interference signals, reconstruct OCT images based on linearized interference signals, and facilitate display of OCT images in the IC. Advantageously, because of at least its integrated nature, the integrated electronic system can achieve shorter latency while provide a cost-effective and reliable solution for fulfilling certain OCT applications. Additionally, complexity of integrating and size of an OCT system can be reduced because, for example, fewer cards or boards are needed or used by the integrated electronic system. Further, performance (e.g., resolution, a-line rate, range depth, throughput, or the like) associated with the OCT system can also be improved compared with other OCT systems that adopt less integrated electronic subsystems.

In some aspects, the techniques described herein relate to an integrated electronic system for optical coherence tomography (OCT), the integrated electronic system including: an integrated circuit (IC) configured to generate image data based on OCT interference signals for display, the IC including: an analog circuit configured to receive and digitize the OCT interference signals to generate digitized interference signals; a core processing subsystem configured to generate the image data based on the digitized interference signals; and a backend processing subsystem configured to receive and cause the image data for display to a user.

In some aspects, the techniques described herein relate to an integrated electronic system, wherein the core processing subsystem includes a neural network (NN) model, a linearization circuit, or a reconstruction algorithm, configured to process the digitized interference signals to generate reconstructed interference signals.

In some aspects, the techniques described herein relate to an integrated electronic system, wherein the NN model is trained using a dataset including a k-clock signal, reconstructed OCT interference signals, and variations of the k-clock signal.

In some aspects, the techniques described herein relate to an integrated electronic system, wherein the core processing subsystem includes a reconstruction pipeline configured to reconstruct the interference signals to generate the image data.

In some aspects, the techniques described herein relate to an integrated electronic system, wherein the backend processing subsystem includes a first path and a second path that are configured to receive and cause the image data for display to the user, and wherein the first path has a lower latency compared to the second path.

In some aspects, the techniques described herein relate to an integrated electronic system, wherein: the analog circuit includes a plurality of analog to digital converters (ADCs) configured to digitize the OCT interference signals to generate digitized interference signals; and the core processing subsystem is configured to generate, depending on an application associated with the integrated electronic system, a control signal to reconfigure the plurality of ADCs.

In some aspects, the techniques described herein relate to an integrated electronic system, further including a printed circuit board (PCB), wherein the IC and a plurality of peripheral components are deployed on the PCB.

In some aspects, the techniques described herein relate to an integrated electronic system, wherein the core processing subsystem is configured to generate a plurality of control signals to control the plurality of peripheral components.

In some aspects, the techniques described herein relate to an integrated electronic system, wherein the analog circuit includes a plurality of digital to analog converters (DACs) configured to convert the plurality of control signals to a plurality of analog signals to control the plurality of peripheral components.

In some aspects, the techniques described herein relate to an integrated electronic system, wherein the plurality of peripheral components include a temperature sensor, a fan, a laser assembly, a camera, an optical sensor, or a micro-electromechanical system (MEMS) assembly.

In some aspects, the techniques described herein relate to an integrated electronic system, further including a graphics processing unit (GPU), and wherein the backend processing subsystem causes the image data to be transmitted to the GPU for display to the user.

In some aspects, the techniques described herein relate to a printed circuit assembly including: an optical detector configured to: receive one or more optical signals; and generate OCT interference signals based at least on the one or more optical signals; an integrated circuit (IC) configured to generate image data based on the OCT interference signals; and an image data interface configured to: receive the image data from the IC; and transmit the image data to an external device for display to a user.

In some aspects, the techniques described herein relate to a printed circuit assembly, wherein the image data interface is a Thunderbolt port, a DisplayPort connector, an OCuLink connector, a Universal Serial Bus (USB) port, a High-Definition Multimedia Interface (HDMI) port, an Ethernet connector, or a Peripheral Component Interconnect Express (PCIe) connector.

In some aspects, the techniques described herein relate to a printed circuit assembly, wherein the IC includes: an analog front end (AFE) configured to receive and digitize the OCT interference signals to generate digitized interference signals; a core processing subsystem configured to generate the image data based on the digitized interference signals; and a backend processing subsystem configured to: receive the image data from the core processing subsystem; and transmit the image data to the image data interface.

In some aspects, the techniques described herein relate to a printed circuit assembly, further including a plurality of peripheral components, and wherein the core processing subsystem is configured to control the plurality of peripheral components.

In some aspects, the techniques described herein relate to a printed circuit assembly, wherein the external device is a laptop, a computer workstation, a discrete graphics card, or a mobile device.

In some aspects, the techniques described herein relate to a printed circuit assembly, wherein the one or more optical signals include an interferometric OCT signal or an interferometric k-clock signal.

In some aspects, the techniques described herein relate to an integrated circuit (IC) including: an analog circuit configured to receive and digitize OCT interference signals to generate digitized interference signals; a core processing subsystem configured to generate image data based on the digitized interference signals; and a backend processing subsystem configured to receive and cause the image data for display to a user.

In some aspects, the techniques described herein relate to an integrated circuit, wherein the core processing subsystem includes a neural network (NN) model configured to reconstruct the digitized interference signals to generate reconstructed interference signals.

In some aspects, the techniques described herein relate to an integrated circuit, wherein the backend processing subsystem includes a first path and a second path that are configured to receive and transmit the image data to the image data interface, and wherein the first path has a lower latency compared to the second path.

Various combinations of the above and below recited features, embodiments, implementations, and aspects are also disclosed and contemplated by the present disclosure.

Additional implementations of the disclosure are described below in reference to the appended claims, which may serve as an additional summary of the disclosure.

### BRIEF DESCRIPTION OF THE DRAWINGS

The following drawings and the associated descriptions are provided to illustrate implementations of the present disclosure and do not limit the scope of the claims. Aspects and many of the attendant advantages of this disclosure will become more readily appreciated as the same become better understood by reference to the following detailed description, when taken in conjunction with the accompanying drawings, wherein:

FIG. 1 is a block diagram illustrating an example OCT system including OCT electronics, according to various implementations of the present disclosure;

FIG. 2 is a block diagram illustrating an example integrated electronic system that can be used to fulfill some or all of functionalities of the OCT electronics of FIG. 1, according to various embodiments of the present disclosure;

FIG. 3 is an example block diagram of analog circuits of the integrated electronic system of FIG. 2, according to various implementations of the present disclosure;

FIG. 4A is an example block diagram of a core processing subsystem of the integrated electronic system of FIG. 2, according to various implementations of the present disclosure;

FIG. 4B is an example block diagram of a reconstruction pipeline of the core processing subsystem of FIG. 4A, according to various implementations of the present disclosure;

FIG. 4C is another example block diagram of the core processing subsystem of the integrated electronic system of FIG. 2, according to various implementations of the present disclosure;

FIG. 5 is a block diagram of a backend processing subsystem of the integrated electronic system of FIG. 2, according to various implementations of the present disclosure;

FIG. 6 illustrates an example integration of at least some portions of the integrated electronic system of FIG. 2, according to various implementations of the present disclosure;

FIG. 7 illustrates example waveforms associated with the integrated electronic system of FIG. 2, according to various implementations of the present disclosure;

FIG. 8 illustrates various laser nonlinearity waveforms, according to various implementations of the present disclosure;

FIG. 9 shows example contour plots illustrating performance requirements on the OCT system of FIG. 1 for certain OCT applications, according to various implementations of the present disclosure; and

FIG. 10 illustrates example waveform associated with the integrated electronic system of FIG. 2, according to various implementations of the present disclosure.

### DETAILED DESCRIPTION

Although certain preferred implementations, embodiments, and examples are disclosed below, the inventive subject matter extends beyond the specifically disclosed implementations to other alternative implementations and/or uses and to modifications and equivalents thereof. Thus, the scope of the claims appended hereto is not limited by any of the particular implementations described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain implementations; however, the order of description should not be construed to imply that these operations are order dependent. Additionally, the structures, systems, and/or devices described herein may be embodied as integrated components or as separate components. For purposes of comparing various implementations, certain aspects and advantages of these implementations are described. Not necessarily all such aspects or advantages are achieved by any particular implementation. Thus, for example, various implementations may be carried out in a manner that achieves or optimizes one advantage or group of advantages as taught herein without necessarily achieving other aspects or advantages as may also be taught or suggested herein.

### Overview

As noted above, optical coherence tomography (OCT) is a widely-used imaging technology for medical, metrology and industrial applications. An OCT system typically employs several discrete boards (e.g., printed circuit boards (PCBs)) and/or cards (e.g., data acquisition cards (DAQs)) deployed with associated optical or electrical components to fulfill various functionalities. For example, an OCT system may utilize one board to capture optical signals for converting to electrical signals, utilize another board to facilitate control on peripheral components (e.g., galvanometer scanners, protection circuitry, or the like), and utilize yet another board to facilitate control on laser modules. Additionally, the OCT system may employ a discrete card for linearizing, processing, and/or reconstructing image data based on digitized interference signals. The OCT system may further use a computer workstation, a laptop, and/or discrete graphics cards for displaying or rendering images to users based on the image data. However, such unintegrated and fragmented implementations may be deficient to meet increased demands associated with OCT systems in at least several aspects.

First, the unintegrated nature of an OCT system may increase latency (e.g., the amount of time taken by the OCT system to generate images based on optical signals) of the OCT system or at least pose a bottleneck to latency, which may be very critical for certain applications (e.g., real-time intraoperative, metrology, and inspection). For example, latency may be introduced by physical interconnections, signal traces, or wires connecting discrete boards and/or cards of the OCT system. The communication (e.g., handshakes or synchronization based on certain communication protocols, converting or decoding among various data formats supported by individual subsystems for data processing, or the like) between the boards and/or cards may result in additional latency.

Second, to achieve superior performance such as generating images with better resolution, higher a-line rate, higher or range depth, signal quality and/or signal bandwidth may be of importance. The unintegrated nature of the OCT system, however, may be undesired for improved signal quality. For example, optical signals captured and converted to electrical signals by an optical detector on a board may be transmitted to analog to digital converters (ADCs) on another board for digitization through transmission lines between boards. During the transmission over physical connections across boards, noise may be introduced to degrade quality (e.g., integrity, signal to noise ratio) of the electrical signals. Additionally, data conversion and decode (e.g., serial to parallel conversion) for processing among discrete boards or cards may inject noise to transmitted signals, leading to inferior signal quality and performance metrics.

Further, to achieve higher throughput, it may be desirable to implement an OCT system that support higher signal bandwidth or sampling rates. Although signal bandwidth may be increased by providing multiple channels for communication, implementing the multiple channels between discrete boards and/or cards may require more hardware (e.g., wires, cables, connectors, interface modules, or the like), which may make the OCT system more complex or difficult to maintain. The use of multiple boards, interface modules, wires, or connectors may further increase size and cost of manufacturing or assembling the OCT system.

Alternatively, higher throughput may be accomplished through increasing sampling rates. For example, the OCT system may adopt ADCs that operate at higher sampling clocks to generate digitized signals with higher sampling rates and transmit the digitized signals to a digital signal processor (DSP) on another board for further processing. Yet, signal interferences between wires or cables across boards may be severe or aggravated while transmitting signals under high frequencies or sampling rates across discrete boards, causing deterioration on performances.

As also noted above, the present disclosure implements an integrated electronic system (e.g., a system-on-a-chip (SoC)) that can advantageously overcome various of the technical challenges mentioned above, among other technical challenges. In some implementations, the integrated electronic system integrates at least some electronic subsystems for realizing OCT related applications within a single integrated circuit (IC). For example, instead of using various boards and/or cards for displaying OCT images, the integrated electronic system can process analog signals converted from optical signals (e.g., OCT interference signals), generate linearized interference signals, reconstruct OCT images based on linearized interference signals, and facilitate display of OCT images in the IC. Advantageously, because of at least its integrated nature, the integrated electronic system can achieve shorter latency while providing a cost-effective and reliable solution for fulfilling certain OCT applications. Additionally, complexity of integrating and the size of an OCT system can be reduced because, for example, fewer cards or boards are needed or used by the integrated electronic system. Further, performance (e.g., resolution, a-line rate, range depth, throughput, or the like) associated with the OCT system can also be improved compared with other OCT systems that adopt less integrated electronic subsystems.

More specifically, the integrated electronic system may achieve shorter latency by integrating various functionalities into an IC (e.g., an application specific integrated circuit (ASIC), a field programmable logic array (FPGA), a combination of an ASIC and a FPGA, or the like) and eliminating the need for some wires, cables, or other connections for connecting multiple boards and/or cards. As such, latency associated with connections among multiple boards may be avoided or reduced at least because of shorter signal paths used by the integrated electronic system for transmitting signals. To further reduce latency, the integrated electronic system may employ a high-speed interface (e.g., a peripheral component interconnect express (PCIe)) for transmitting reconstructed OCT images to a host computer and/or post processing circuitry for processing and then displaying. Additionally, and/or optionally, the integrated electronic system can integrate the IC and an optical detector on a single board (e.g., a PCB). As such, latency associated with the signal path between the optical detector and analog circuits of the IC can also be reduced because of shortened transmission paths.

To achieve higher throughput, the integrated electronic system may utilize multiple channels for receiving and/or transmitting optical signals and analog signals. In some implementations, the analog circuits of the IC may use eight channels (e.g., each channel having one ADC) to digitize analog signals in parallel, and transmit digitized signals in parallel for linearization and/or image reconstruction. Compared with other OCT systems in which analog and digital circuits are deployed on different boards, implementing the multiple channels within the IC of the integrated electronic system may not increase complexity of system integration or result in inferior signal qualities associated with transmitting signals using wires across boards.

Additionally, the elimination of certain connections and/or data format conversion (e.g., serial to parallel conversion) across boards can be conducive to maintenance of signal quality because of less injection of noise during communication. Additionally, and/or optionally, by integrating optical detector(s) and the IC on the same board, noise immunity associated with the signal path between the optical detector(s) and analog circuits of the IC may be enhanced. As such, superior system performance (e.g., higher resolution, better signal to noise (SNR) ratio) may be achieved.

### Example Features Related to System Integration

As noted above, the integrated electronic system may achieve superior performance through at least integrating various electronic subsystems for OCT applications in an IC as an SoC. In some implementations, the integrated electronic system may include analog circuits (e.g., an analog front end, ADCs, and DACs), a core processing subsystem, and a backend processing subsystem. The core processing subsystem, the backend processing subsystem, and at least some portions of the analog circuits may all be implemented in the IC. Additionally, and/or optionally, the integrated electronic system may further include an optical detector for receiving and converting optical signals (e.g., OCT interference signals) into electrical signals (e.g., electrical forms of the OCT interference signals). The optical detector and the IC may be both deployed on a board (e.g., a PCB). To accomplish higher level of system integration, some peripherals (e.g., a laser module, camera, thermal detectors, micro-electromechanical system (MEMS), or the like) may also be deployed on the board.

### Example Features Related to Analog Circuits

The integrated electronic system may process electrical signals received from an optical detector to generate digital signals. In some implementations, the integrated electronic system may include a plurality of channels (e.g., two, four, eight, twelve, or the like) for receiving electrical signals (e.g., OCT interference signals) converted by the optical detector. Each of the plurality of channels may include an ADC that digitizes the electrical signals (e.g., k-clock signals, OCT interference signals). As noted above, the ADCs and the optical detector may be deployed on the same board, thereby achieving better noise immunity and cost reduction. Advantageously, the plurality of channels enables the integrated electronic system to provide larger signal bandwidth to achieve improved performance (e.g., higher throughput).

The integrated electronic system may further include a plurality of channels for transmitting control signals generated by the core processing subsystem and/or the backend processing subsystem to control peripherals on a board. Each of the plurality of channels for transmitting control signals may include a digital to analog converter (DAC) that converts digital signals to analog signals for controlling the peripherals.

### Example Features Related to Core Processing Subsystem

The integrated electronic system may process the electrical signals received from the analog front end to generate image data. In some implementations, the integrated electronic system (e.g., a signal processing engine) may linearize and/or reconstruct image data based on k-clock signals and OCT interference signals. The integrated electronic system may utilize a neural network (NN) model for reconstructing OCT interference signals. The NN model may be trained using datasets including k-clock signals, corresponding linearized OCT interference signals as well as variations of the k-clock signals to achieve better performance on linearization. Based on linearized interference signals, the integrated electronic system (e.g., a reconstruction pipeline) may further reconstruct image data through operations including background noise removal, dispersion compensation, FFT, log scaling, display-scaling, or the like.

The integrated electronic system (e.g., an acquisition engine) may transmit image data to the backend processing system for displaying or rendering OCT images. In some implementations, the integrated electronic system may include two paths for displaying OCT images. To reduce latency for certain applications, the integrated electronic system may utilize a high-speed path to transmit image data for displaying. The high-speed path may utilize PCIe interface for data transmission. For applications where latency is less critical, the integrated electronic system may utilize a normal speed path (e.g., through a memory controller) to transmit image data for displaying.

Additionally, the integrated electronic system may establish a direct and low latency communication channel between the analog circuits, peripherals on board, and/or the core processing subsystem. For example, the acquisition engine may generate control signals to facilitate high speed control on the analog circuits and/or the peripherals. Because the acquisition engine may operate at higher speeds, clock rates, and/or without the need of firmware intervention (e.g., compared with the backend processing system), control on the analog circuits and/or the peripherals may be conducted in more real-time manner to timely respond to or adjust the integrated electronic system to achieve better performance. Additionally, and/or optionally, the acquisition engine may control the analog circuits and/or the peripherals based on settings or parameters received from the backend processing subsystem.

In some examples, the integrated electronic system (e.g., the acquisition engine) may reconfigure the analog circuits depending on applications. For example, the integrated electronic system may disable certain channels in the analog circuits in applications where the integrated electronic system does not need to linearize OCT interference signals. In other applications, the integrated electronic system may enable more channels in the analog circuits and/or increase sampling rates associated with the analog circuits.

### Example Features Related to Backend Processing Subsystem

The integrated electronic system (e.g., a backend processing subsystem) may transmit and/or process image data generated by the core processing subsystem to facilitate display of OCT images. In some implementations, instead of using a computer workstation for displaying OCT images, the integrated electronic system may transmit image data through a display port interface to a display unit for displaying OCT images. By integrating the display port interface and the SoC on the same board, latency may be significantly reduced (e.g., from a couple of milliseconds to tens of milliseconds).

Additionally and/or optionally, depending on applications, the integrated electronic system may employ a graphics processing unit (GPU) for rendering image data generated by the core processing subsystem. For example, when used for applications where intensive image processing may be necessary such as feature recognition, detecting cancer and detachment of tissue, the integrated electronic system may transmit the image data to the GPU for rendering. In some implementations, the GPU may be on a separate board distinct from the board in which the SoC is deployed.

### Example Features Related to Peripheral Control

As noted above, the integrated electronic system may integrate some peripherals and the IC that includes ADCs and DACs, the core processing subsystem, and the backend processing subsystem on the same board. The peripherals may be controlled by the IC to implement certain control and protection functionalities. For example, the IC may control a camera that capture optical signals through a MEMS module deployed on the board. As another example, the IC may coordinate with temperature sensors and fans to facilitate thermal protection (e.g., cooling) on the IC to avoid overheating of the IC resulted from intensive computation and synchronization operations performed by the IC. As still another example, the IC may transmit control signals to the peripherals to facilitate various functionalities such as calibration on the laser module or the camera. By integrating the peripherals and IC on the same board and utilizing high speed logic (e.g., the core processing subsystem) to generate control signals for controlling peripherals, calibration and/or adjustment associated with the integrated electronic system may be performed in real-time.

### Further Example Information Related to Various Implementations

To facilitate an understanding of the systems and methods discussed herein, several terms are described below and herein. These terms, as well as other terms used herein, should be construed to include the provided descriptions, the ordinary and customary meanings of the terms, and/or any other implied meaning for the respective terms, wherein such construction is consistent with context of the term. Thus, the descriptions below and herein do not limit the meaning of these terms, but only provide example descriptions.

The term “model,” as used in the present disclosure, can include any computer-based models of any type and of any level of complexity, such as any type of sequential, functional, or concurrent model. Models can further include various types of computational models, such as, for example, artificial neural networks (“NN”), language models (e.g., large language models (“LLMs”)), artificial intelligence (“AI”) models, machine learning (“ML”) models, multimodal models (e.g., models or combinations of models that can accept inputs of multiple modalities, such as images and text), and/or the like.

The term “OCT signals” can refer to light signals that are used in an OCT system. OCT signals can originate from a light source and be directed towards the sample being imaged. OCT signals can include OCT interference signals and other light signals that are used in an OCT system. OCT interference signals can be a result of a combination of light backscattered from the sample and the light reflected from a reference mirror.

### Example OCT System

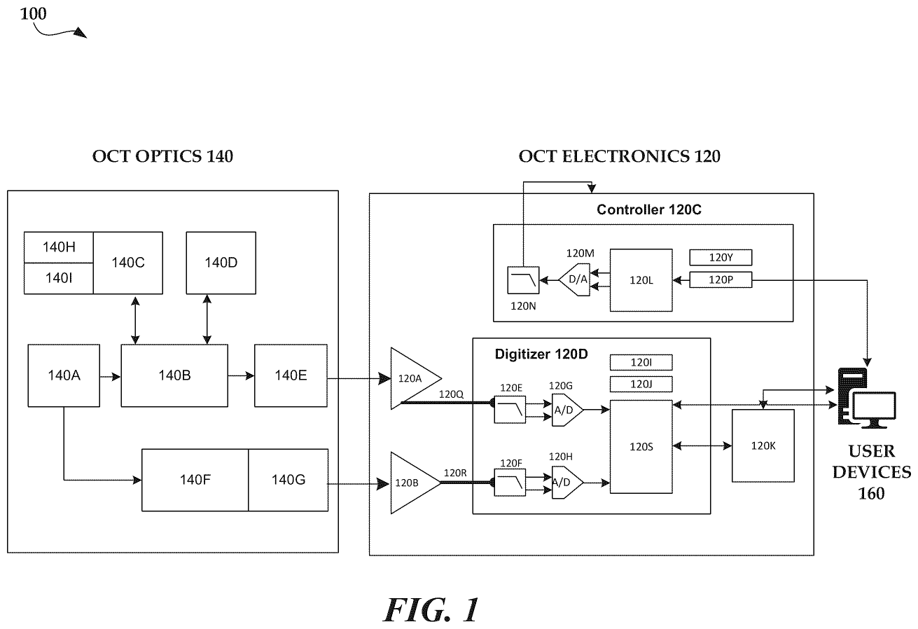

FIG. 1 illustrates an example optical coherence tomography (OCT) system 100. The example OCT system 100 includes OCT optics 140, OCT electronics 120, and user devices 160. The OCT optics 140 includes a light source 140A, an interferometer 140B, photodetectors 140E and 140G, k-clock interferometer 140F, scanner 140H, safety interlock 1401, sample arm 140C, and reference arm 140D. Inside the OCT optics 140, light from the light source 140A (e.g., a broadband light source with short temporal coherence light, a wavelength tunable laser source, or the like) may be emitted and routed to illuminate a sample (e.g., tissues in a human eye, not shown in FIG. 1). Light scattered from the sample may be collected and combined with reference light to form OCT interference signals. The OCT interference signals may be detected and converted by an optical detector to electrical representations (e.g., current and/or voltage) of the OCT interference signals to be processed by the OCT electronics 120 for generating OCT images that may be transmitted to and displayed on the user devices 160.

In some examples, the light source 140A may be a broadband light source with short temporal coherence, such as a wavelength-tunable laser. The light source emits a beam of light that is directed into the interferometer 140B. In Swept-Source OCT (SS-OCT), a tunable laser is used to sweep through a range of wavelengths, providing the necessary spectral information for imaging. The interferometer 140B may split the light from the light source 140A into two paths the respectively correspond to the sample arm path and the reference arm. The interferometer 140B may use a beam splitter to divide or split the light. In the sample arm 140C, the light is directed towards a biological tissue or the sample being imaged. The light penetrates the tissue or the sample, and is scattered back from different depths within the sample. The scattered light carries information about the internal structure of the tissue or the sample. In the reference arm 140D, the light is directed towards a reference mirror. The reference mirror reflects the light back towards the beam splitter. The reference arm provides a known reference path length, which is used for creating interference patterns when combined with the light from the sample arm.

In some examples, the photodetectors 140E and 140G are used to detect the interference signals created when the light from the sample arm and the reference arm recombine at the beam splitter. The interference pattern contains information about the depth and structure of the sample. Photodetectors 140E and 140G convert the optical interference signals into electrical signals that can be processed by the OCT electronics 120. The k-clock interferometer 140F is used in Swept-Source OCT systems to generate a k-clock signal. This signal provides information about the instantaneous wavenumber of the swept laser source, which is used for linearizing the interference signals in the wavenumber domain. The k-clock signal helps correct for non-linearities in the laser sweep. The scanner 140H (e.g., a galvanometer scanner), is used to direct the light beam across the sample in a controlled manner. By scanning the light beam in two dimensions, the OCT system 100 can create a cross-sectional or volumetric image of the sample. The scanner ensures that different regions of the sample are illuminated and imaged sequentially. The safety interlock 1401 is a protective mechanism that ensures the OCT system 100 operates within safe limits. It can include features such as power monitoring and automatic shutdown to prevent excessive exposure to the light source, which could potentially harm the sample or a user.

As shown in FIG. 1, typical OCT electronics 120 includes a plurality of discrete components (e.g., amplifiers 120A and 120B, a digitizer 120D, a controller 120C, and a GPU 120K) that have to be connected with each other using wires, cables, connectors, and/or the like. Some of these components (e.g., the digitizer 120D and the controller 120C) include even more granular discrete components (e.g., a FPGA 120S, a processor 1201, a memory 120J, a FPGA 120L, a processor 120Y, a memory 120P). The digitizer 120D and/or the controller 120C, for example, utilizes discrete chips that are connected on printed circuit boards. In some examples, the amplifiers 120A and 120B are used to convert the captured OCT interference signal (e.g., captured using the photodetector 140E) from current into voltage, then amplify the OCT interference signal. Within the digitizer 120D, components 120E and 120F are used for signal conditioning and converting the signal to differential signal, and components 120G and 120H can convert the analog signal into digital signal. The digital signal is then passed to the FPGA 120S for data manipulation, processing, linearizing, processing, and/or reconstructing image data.

The image data can be passed to the user device 160 (e.g., a computer or a mobile device) and GPU 120K. The digitizer 120D utilizes processor 1201 and memory 120J to perform certain tasks. Within the controller 120C, the FPGA 120L is used for data manipulation and processing, and to communication with the user device 160. The data generated by the FPGA 120L is then passed to the digital to analog converter 120M and a signal conditioning module 120N to control peripheral components e.g., scanners 140H and safety interlock 1401. In discrete electronics systems like what is shown in FIG. 1, communication between some critical parts are usually facilitated using one or more cables 120Q and 120R, which cause limitations on electronics characteristics like bandwidth and noise characteristics. Similarly, the separate packages of discrete components on the board cause limitation on performance with respect to bandwidth and noise. As noted above, it may be desirable to integrate some or all of the components of the controller 120C and the digitizer 120D of the OCT electronics 120 to improve performance, reliability, or reduce cost.

### Example Integrated Electronic System and Block Diagrams

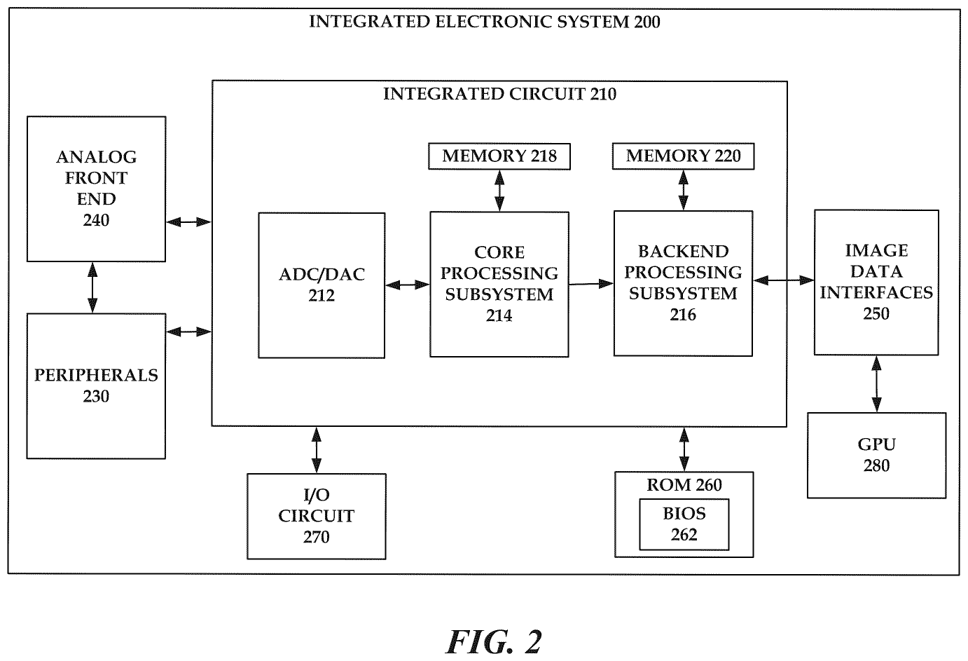

FIG. 2 depicts an example integrated electronic system 200, according to various implementations of the present disclosure. In various implementations, the integrated electronic system 200 may be used to replace the OCT electronics 120 and/or fulfill some or all functionalities of the OCT electronics 120 in the OCT system 100. In contrast to the OCT electronics 120, the integrated electronic system 200 may be implemented on a single board (e.g., a PCB, a mainboard, a motherboard, or the like) according to some implementations. As shown in FIG. 2, the integrated electronic system 200 includes an integrated circuit 210, peripherals 230, an analog front end 240, image data interfaces 250, an input/output (I/O) circuit 270, a read-only-memory (ROM) 260 that includes a basic input/output system (BIOS) 262, and a graphics processing unit (GPU) 280.

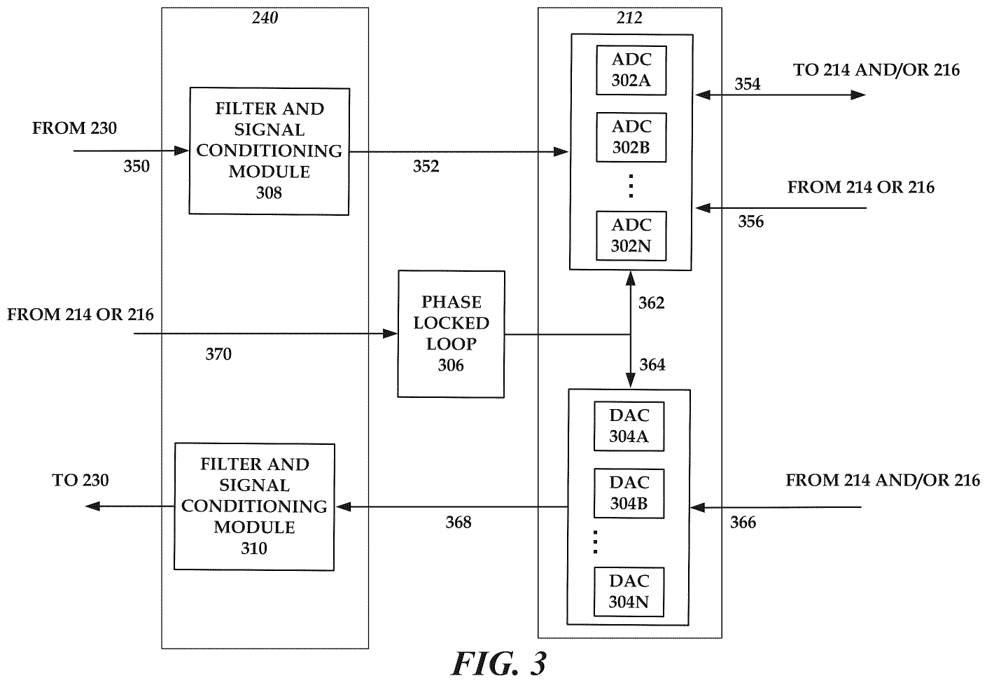

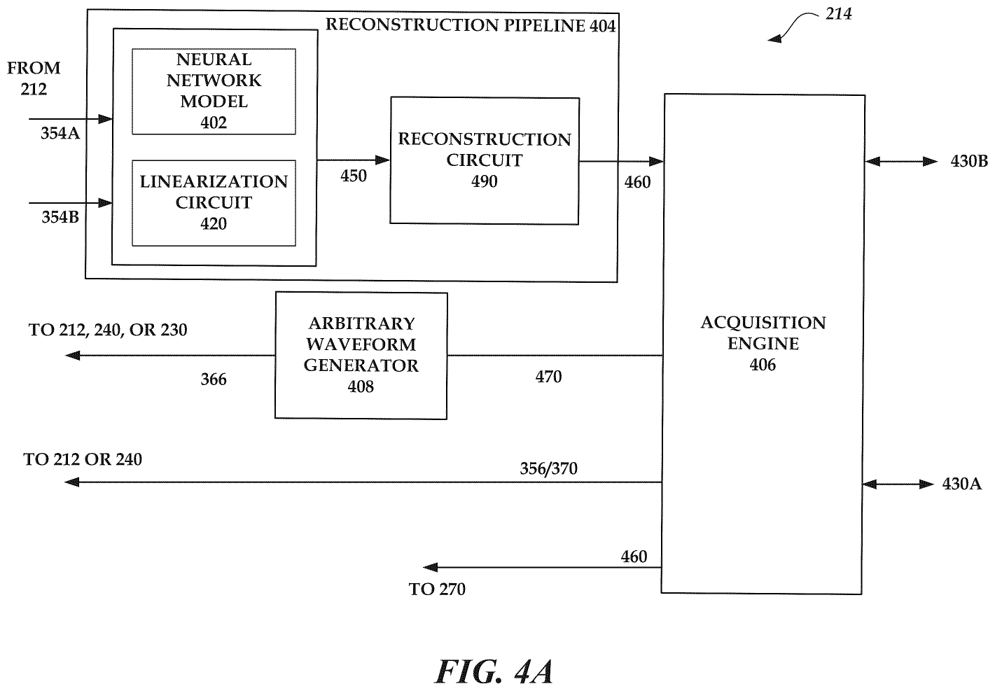

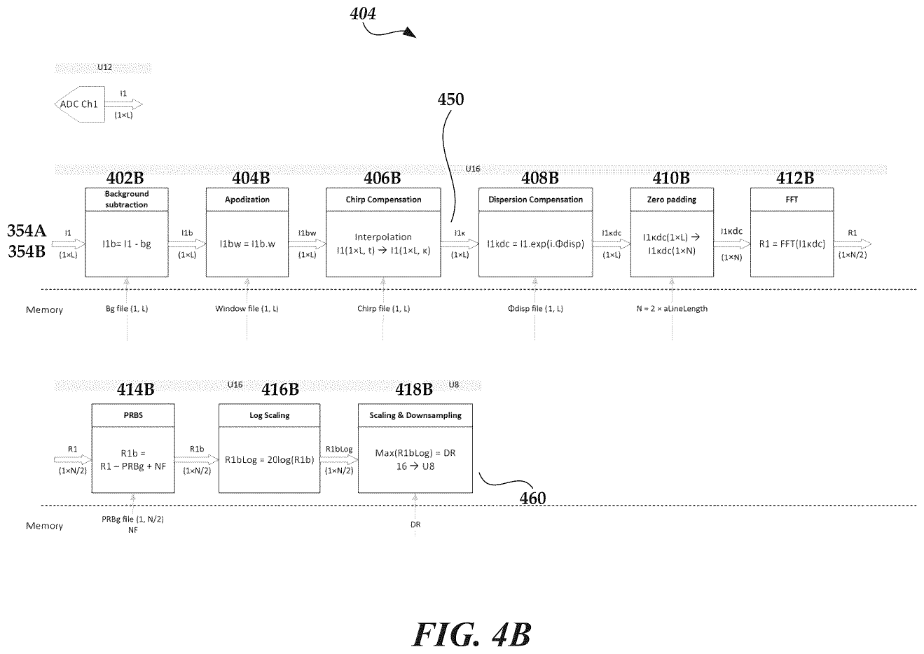

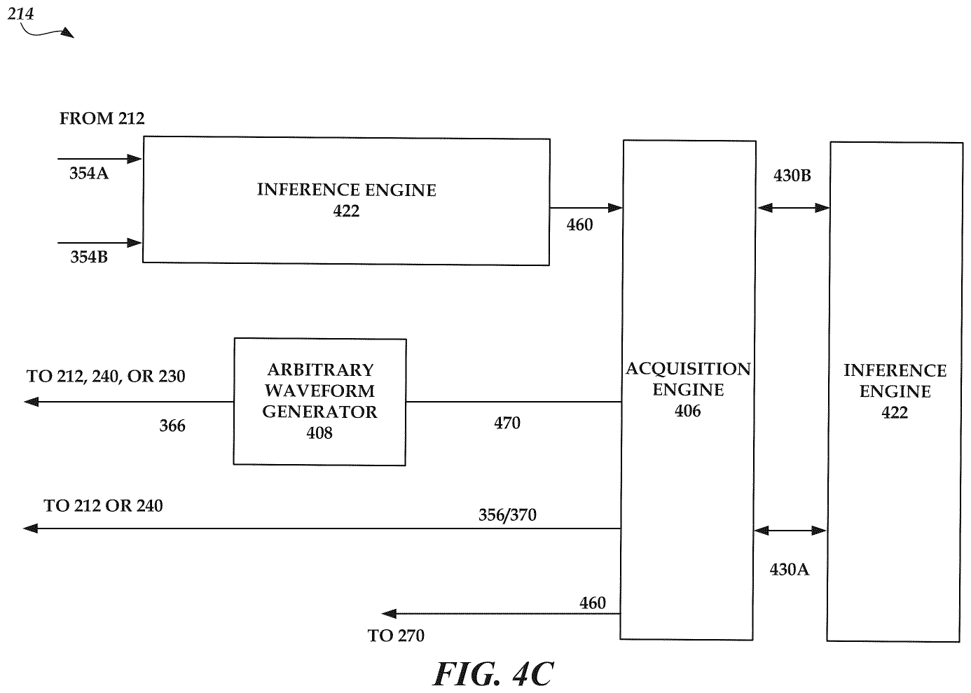

The integrated circuit 210 includes ADC/DAC 212 that can include one or more analog to digital converters (ADCs) and/or one or more digital to analog converters (DACs), a core processing subsystem 214, and a backend processing subsystem 216. The integrated circuit 210 can optionally include a memory 218 and a memory 220. The memory 218 can be dedicated to and accessed by the core processing subsystem 214. The memory 220 can be dedicated to and accessed by the backend processing subsystem 216. The core processing subsystem 214 and the backend processing subsystem 216 can include one or more processors and programmable logics (PLs) for performing various signal processing and arithmetic operations. The indicated connections and/or data flows of FIG. 2 are exemplary of only certain processing performed by the integrated electronic system 200 and is not meant to include all possible blocks and participants. Further, portions or some of the blocks (e.g., the I/O circuit 270, the ROM 260, the image data interfaces 250, the GPU 280) may be optional to the integrated electronic system 200 or may be integrated into the integrated circuit 210. As indicated in FIG. 2, the ADC/DAC 212, the analog front end 240, and/or the peripherals 230 may be controlled by the core processing subsystem 214 and/or the backend processing subsystem 216. For example, the core processing subsystem 214 may control the peripherals 230 through the ADC/DAC 212. More detailed descriptions about using the integrated circuit 210 to control components (e.g., the peripherals 230) of the integrated electronic system 200 will be discussed with reference to FIGS. 3 and 4A.

In some examples, the peripherals 230 may include an optical detector, a laser module, a camera, a thermal detector, a micro-electromechanical system (MEMS), a fan, and/or the like. The peripherals 230 may facilitate or perform some functionalities associated with the OCT optics 140. For example, the laser module may serve as a light source to emit light to illuminate a sample, and the optical detector may detect and convert OCT interference signals to analog signals. Operations associated with the peripherals 230 will be further described below. In some examples, the peripheral 230 can be controlled by the integrated circuit 210 to generate position data. The position data can be read and processed by the integrated circuit to determine accurate position(s) associated with the peripherals 230. The peripherals 230 may optionally controlled by the integrated circuit 210 to generate data that can be processed by the integrated circuit 210 to measure light power and/or determine status associated with the peripherals 230. In some examples, the peripherals 230 may include scanning image subsystems including light sources or scanning devices (e.g., scanning laser ophthalmoscope or light scanning aberrometry). The integrated circuit 210 may control or process data generated by the scanning image subsystems (e.g., controlling light sources and/or reads signal from scanning beams).

In some examples, the I/O circuit 270 may be any interface circuitry that can receive and/or transmit data generated by the integrated circuit 210. The I/O circuit 270 may include a plurality of general purpose input/output (GPIO) pins for receiving, transmitting, and/or storing the data from the integrated circuit 210. In some examples, the I/O circuit 270 may be implemented within the integrated circuit 210 as a part of a system-on-a-chip (SoC). The I/O circuit 270 may optionally include interface circuitry to facilitate communications with and/or control on the integrated circuit 210. For example, the I/O circuit 270 may include an Inter-Integrated Circuit (I2C), an Improved Inter-Integrated Circuit (I3C), a Serial Peripheral Interface (SPI), a Controller Area Network (CAN bus), a Universal Asynchronous Receiver/Transmitter (UART), or the like.

In some examples, the memory 218, and/or the memory 220 may be embodied as any type of volatile or non-volatile memory or data storage, such as dynamic random access memory (DRAM), static random access memory (SRAM), synchronous DRAM (SDRAM), double data rate synchronous dynamic random access memory (DDR SDRAM), or Reduced-Latency DRAM (RLDRAM). The memory 218 and/or the memory 220 may store various data and program code used during operation of the integrated electronic system 200, including operating systems (e.g., a real-time operating system (RTOS)), application programs, libraries, driver, and the like. As noted above, the memory 218 can be communicatively coupled to the core processing subsystem 214, and the memory 220 can be communicatively coupled to the backend processing subsystem 216.

In some examples, the BIOS 262 refers to hardware or hardware and instructions to initialize, control, or operate a computing device prior to execution of an operating system (e.g., a real-time operating system (RTOS)) of the integrated electronic system 200. Instructions included within the BIOS 262 may be software, firmware, microcode, or other programming that defines or controls functionality or operation of a BIOS 262. In one example, the BIOS 262 may be implemented using instructions, such as platform firmware of the integrated electronic system 200, executable by a processor. The BIOS 262 may operate or execute prior to the execution of the RTOS of the integrated electronic system 200. The BIOS 262 may initialize, control, or operate components such as hardware components of a computing device and may load or boot the RTOS of the integrated electronic system 200. In some examples, the BIOS 262 may provide or establish an interface between hardware devices or platform firmware of the integrated electronic system 200 and an RTOS of the integrated electronic system 200, via which the RTOS of the integrated electronic system 200 may control or operate hardware devices or platform firmware of the integrated electronic system 200. In some examples, the BIOS 262 may implement the Unified Extensible Firmware Interface (UEFI) specification or another specification or standard for initializing, controlling, or operating the integrated electronic system 200. The BIOS 262 may be stored by a memory, such as the ROM 260, flash memory (not shown in FIG. 2), or other non-volatile memory.

In some examples, the image data interfaces 250 may be embodied as any interface circuitry, ports, and/or slots supporting communication protocols/interfaces for receiving and/or transmitting image data generated by the integrated circuit 210 for displaying OCT images to user devices 160 (e.g., monitors, mobile devices, or the like). For example, the image data interfaces 250 may include or support various protocols, interfaces, and/or connections such as DisplayPort, High-Definition Multimedia Interface (HDMI), Universal Serial Bus (USB), Peripheral Component Interconnect Express (PCIe), Serial Advanced Technology Attachment (SATA), thunderbolt ports, lightning connectors, and/or the like.

In some examples, the GPU 280 may be an integrated circuit device and can be utilized for applications such as image rendering. In some examples, the GPU 280 may be incorporated into a board in which the integrated circuit 210 is also deployed. Alternatively, the GPU 280 may be deployed on a graphics card or a daughter board to be connected to a mainboard in which the integrated circuit 210 is deployed. In some examples, the GPU 280 may work in conjunction with the integrated circuit 210 directly and/or through the image data interfaces 250 to perform tasks such as 3D video rendering. In some examples, a volatile memory (e.g., DDR memory) and/or a non-volatile memory (e.g., solid-state drive) not shown in FIG. 2 may be dedicated for the GPU 280 for rendering. In some embodiments, the integrated electronic system 200 (e.g., an electronic board) may include the GPU 280 and/or is paired with a GPU (not shown in FIG. 2) for acceleration of processing or inference.

In some examples, the integrated circuit 210 may be embodied as an integrated circuit device, an application specific integrated circuit (ASIC), a field programmable logic array (FPGA), a combination of an ASIC and a FPGA, or the like. The integrated circuit 210 can include one or more semiconductor dies and can be manufactured using any suitable semiconductor process or technology, such as the complementary metal-oxide-semiconductor (CMOS) technology. In some examples, the integrated circuit 210 may perform some or all of the functionalities associated with the plurality of discrete components 120A-120D of the OCT electronics 120.

Compared with the OCT electronics 120, the integrated circuit 210 may achieve shorter latency and improved signal integrity through eliminating the need for some wires, cables, or other connections for connecting between the plurality of discrete components 120A-120D. Latency associated with connections among the plurality of discrete components 120A-120D may be avoided or reduced at least because of shorter signal paths used by the integrated circuit 210 for transmitting and receiving signals. Additionally, the integrated circuit 210 may reduce potential sources of signal degradation to achieve improved signal integrity, such as impedance mismatches, electromagnetic interference, crosstalk, and/or the like. The integrated circuit 210 may further employ a high-speed interface (e.g., a peripheral component interconnect express (PCIe)) for transmitting reconstructed OCT images to a host computer for further processing, analysis, and display. Through coordination with the host computer, and/or utilizing direct display interfaces (e.g., DisplayPort, HDMI, or something similar) for transmitting, processing, and/or displaying images, the integrated electronic system 200 may achieve reduced latency for displaying images. A combination of the two paths (e.g., the path associated with the host computer and the path associated with direct display interfaces) can be also used to facilitate simultaneous real-time display and recording of data on the host computer. Additionally, and/or optionally, the integrated circuit 210 and at least some of the peripherals 230 (e.g., an optical detector) may be deployed on a single board such that latency associated with the signal path between the optical detector and the integrated circuit 210 can also be reduced because of shortened transmission paths, direct on-chip reconstruction, and direct projection to display. The integrated circuit 210 may utilize multiple channels for receiving and/or transmitting electrical signals. In some examples, the integrated circuit 210 may use multiple (e.g., four, six, seven, eight, ten, twelve) channels to digitize analog signals (e.g., OCT interference signals received from an optical detector of the peripherals) in parallel, and transmit digitized signals in parallel for linearization and/or image reconstruction.

Compared with the OCT electronics 120 in which analog and digital circuits may be deployed on different instances of the plurality of discrete components 120A-120D, implementing the multiple channels within the integrated circuit 210 may not increase complexity of system integration or result in inferior signal qualities associated with transmitting signals using wires across discrete components 120A-120D. Additionally, the elimination of certain connections and/or data format conversion (e.g., serial to parallel conversion) across the plurality of discrete components 120A-120D can be conducive to maintenance of signal qualities because of less injection of noises during communication. Additionally, and/or optionally, by integrating some peripherals 230 (e.g., an optical detector) and the integrated circuit 210 on the same board, noise immunity associated with the signal path between the optical detector and the integrated circuit 210 may be enhanced. As such, superior system performance (e.g., higher resolution, better signal to noise (SNR) ratio) may be achieved based on the integrated circuit 210.

As noted above, the integrated circuit 210 may include the ADC/DAC 212, the core processing subsystem 214, and the backend processing subsystem 216. The ADC/DAC 212 may process electrical signals received from the analog front end 240 and the peripherals 230 (e.g., an optical detector) to generate digital signals. In some examples, the analog front end 240 may filter and perform signal conditioning on signals output by the optical detector for the ADC/DAC 212 to perform further signal processing. The ADC/DAC 212 may include a plurality of channels (e.g., two, four, eight, twelve, or the like) for receiving electrical signals (e.g., OCT interference signals) converted by the optical detector. Each of the plurality of channels may include an ADC that digitizes the electrical signals (e.g., k-clock signals, OCT interference signals). In some examples, the ADCs and the optical detector may be deployed on the same board, thereby achieving better noise immunity and cost reduction. Advantageously, the plurality of channels may enable the ADC/DAC 212 to provide larger signal bandwidth to achieve improved performance (e.g., higher throughput). The ADC/DAC 212 may further include a plurality of channels for transmitting control signals generated by the core processing subsystem 214 and/or the backend processing subsystem 216 to control the peripherals 230. Each of the plurality of channels for transmitting control signals may include a digital to analog converter (DAC) that converts digital signals to analog signals for controlling the peripherals 230 and/or the analog front end 240.

The core processing subsystem 214 may process the electrical signals from the ADC/DAC 212 to generate image data. In some examples, the core processing subsystem 214 (e.g., a signal processing engine) may linearize and/or reconstruct image data based on k-clock signals and OCT interference signals. The core processing subsystem 214 may utilize a neural network (NN) model for linearizing OCT interference signals. The NN model may be trained using datasets including k-clock signals, corresponding linearized OCT interference signals as well as variations of the k-clock signals to achieve better performance on linearization. Based on linearized interference signals, the core processing subsystem 214 (e.g., a reconstruction pipeline) may further reconstruct image data through operations including background noise removal, dispersion compensation, FFT, log scaling, display-scaling, or the like. The core processing subsystem 214 (e.g., an acquisition engine) may transmit image data to the backend processing subsystem 216 for displaying or rendering OCT images. In some examples, the core processing subsystem 214 and the backend processing subsystem 216 may include two paths for displaying OCT images. To reduce latency for certain applications, the core processing subsystem 214 and the backend processing subsystem 216 may utilize a high-speed path to transmit image data for displaying. The high-speed path may utilize PCIe interface for data transmission. For applications where latency is less critical, the core processing subsystem 214 and the backend processing subsystem 216 may utilize a normal speed path (e.g., through a memory controller) to transmit image data for displaying.

Additionally, the core processing subsystem 214 may establish a direct and low latency and high-synchronized communication channel between the ADC/DAC 212, the analog front end 240, and/or the peripherals 230. For example, core processing subsystem 214 may generate control signals to facilitate high speed control on the ADC/DAC 212, the analog front end 240, and/or the peripherals 230. Because the core processing subsystem 214 may operate at higher speeds, clock rates, and/or without the need of firmware intervention (e.g., compared with the backend processing subsystem 216), control on the ADC/DAC 212, the analog front end 240, and/or the peripherals 230 may be conducted in more real-time manner to timely respond to or adjust the integrated electronic system 200 to achieve better performance. Additionally, and/or optionally, the core processing subsystem 214 may control the ADC/DAC 212, the analog front end 240, and/or the peripherals 230 based on settings or parameters received from the backend processing subsystem 216. In some examples, the core processing subsystem 214 (e.g., the acquisition engine) may reconfigure the ADC/DAC 212 depending on applications. For example, the core processing subsystem 214 may disable certain channels in the ADC/DAC 212 in applications where the integrated circuit 210 does not need to linearize OCT interference signals. In other applications, the core processing subsystem 214 may enable more channels in the ADC/DAC 212 and/or increase sampling rates associated with the ADC/DAC 212.

The backend processing subsystem 216 may transmit and/or process image data generated by the core processing subsystem 214 to facilitate display of OCT images. Instead of using a computer workstation for displaying OCT images, the backend processing subsystem 216 may transmit image data directly through the image data interfaces 250 to a display unit (not shown in FIG. 2). In some examples, by integrating the image data interfaces 250 and the integrated circuit 210 on the same board, latency may be significantly reduced (e.g., from hundreds of milliseconds to tens of milliseconds). Additionally, and/or optionally, depending on applications, the backend processing subsystem 216 may employ the GPU 280 for rendering image data generated by the core processing subsystem 214. For example, when used for applications where intensive image processing may be necessary such as feature recognition, detecting cancer and detachment of tissue, the backend processing subsystem 216 may transmit (indirectly through the image data interfaces 250, or directly to the GPU 280) image data to the GPU 280 for rendering.

In some examples, the core processing subsystem 214 and/or the backend processing subsystem 216 may control the peripherals 230 to implement certain control and protection functionalities. For example, the core processing subsystem 214 and/or the backend processing subsystem 216 may control a camera of the peripherals 230 to capture optical signals through a MEMS module of the peripherals 230. As another example, the core processing subsystem 214 and/or the backend processing subsystem 216 may coordinate with a temperature sensor and a fan of the peripherals 230 to facilitate thermal protection (e.g., cooling) on the integrated circuit 210 to avoid overheating the integrated circuit 210, which may result from intensive computation and synchronization operations performed by the integrated circuit 210. As still another example, the core processing subsystem 214 and/or the backend processing subsystem 216 may transmit control signals to the peripherals 230 to facilitate various functionalities such as calibration on the laser module or the camera of the peripherals 230. As yet another example, the peripherals 230 may include interfaces or circuits for controlling motor(s) in the integrated electronic system 200. The core processing subsystem 214 and/or the backend processing subsystem 216 may transmit control signals to the peripherals 230 to control the motor(s) in the integrated electronic system 200. By integrating the peripherals 230 and integrated circuit 210 on the same board and utilizing high speed logic (e.g., the core processing subsystem 214) to generate control signals for controlling peripherals, calibration and/or adjustment associated with the integrated electronic system 200 may be performed in real-time to achieve better performance compared with the OCT electronics 120.

### Additional Example Implementations and Operations of the System

FIG. 3 illustrates an example block diagram of the ADC/DAC 212 and the analog front end 240, according to various implementations of the present disclosure. As shown in FIG. 3, the ADC/DAC 212 includes analog to digital converters (ADCs) 302A through 302N, digital to analog converters (DACs) 304A through 304N. The analog front end 240 includes a filter and signal conditioning module 308, and a filter and signal conditioning module 310. A phase locked loop (PLL) 306 can be included in the ADC/DAC 212 or the analog front end 240. N may be any positive integer such that any number of ADCs and DACs can be accommodated by the ADC/DAC 212.

Each of the ADCs 302A through 302N may correspond to a communication channel for digitizing electrical signals (e.g., OCT interference signals, k-clock signals, scan trigger signals) received from the analog front end 240 in parallel to increase signal bandwidth. In some examples, each of the ADCs 302A through 302N may be a 12-bit, 14-bit, 16-bit ADC. Alternatively, each of the ADCs 302A through 302N may generate a digital output that has a different number of bits. Each of the ADCs 302A through 302N may be embodied as a successive approximation (SAR) ADC, delta-sigma ADC, dual slope ADC, pipelined ADC, flash ADC, or the like.

The filter and signal conditioning module 308 may include one or more analog anti-aliasing filters that filter OCT interference signals before the ADCs 302A through 302N digitize the OCT interference signals. In some examples, each of the ADCs 302A through 302N may be paired with each of the one or more analog anti-aliasing filters. A cut-off frequency of an analog anti-aliasing filter may be approximately equal to or lower than the bandwidth of a corresponding one of the ADCs 302A through 302N. The filter and signal conditioning module 308 may also condition the OCT interference signals such that the ADCs 302A through 302N may effectively or accurately digitize the OCT interference signals. For example, the filter and signal conditioning module 308 may adjust amplitudes or swings of the OCT interference signals to maintain signal to noise ratio (SNR).

The filter and signal conditioning module 310 may include one or more analog anti-aliasing filters that filter analog signals received from the DACs 304A through 304N. The filter and signal conditioning module 310 may also condition the OCT analog signals from the DACs 304A through 304N for robust control on the peripherals 230.

The PLL 306 may generate high-quality clock sources with low jitter to clock the ADCs 302A through 302N, and the DACs 304A through 304N directly or indirectly to achieve improved jitter and synchronization performance. The PLL 306 may be embodied as an analog phase-locked loop (APLL), a linear phase-locked loop (LPLL), a digital phase-locked loop (DPLL), an all-digital phase-locked loop (ADPLL), a software phase-locked loop (SPLL), or any combination thereof. In some examples, the ADCs 302A through 302N may be clocked by the PLL 306 such that the ADCs 302A through 302N may generate digitized samples of electrical signals received from the peripherals 230 at a data rate that is at least one giga sample per second (GSPS) or five GSPS.

In some examples, the filter and signal conditioning module 308 may filter the electrical signals 350 that are received from the peripherals 230 and the analog front end 240 to generate the electrical signals 352 for the ADCs 302A through 302N. Based on the control signals 362 (e.g., clock signals) provided by the PLL 306, the ADCs 302A through 302N may digitize the electrical signals 352 to generate digitized signals 354 that may be further processed by the core processing subsystem 214. For example, the electrical signals 350 may include OCT interference signals detected and converted by an optical detector of the peripherals 230, and the digitized signals 354 may include digitized interference signals that form a digital representation of the OCT interference signals. As another example, the electrical signals 350 may include a k-clock signal provided by a laser module (e.g., using a Mach-Zehnder interferometer (MZI)) of the peripherals 230, and the digitized signals 354 may include digitized k-clock signal that forms a digital representation of the k-clock signal.

In some examples, the core processing subsystem 214 and/or the backend processing subsystem 216 may reconfigure the ADCs 302A through 302N using control signals 356, depending on applications. For example, using the control signals 356, the core processing subsystem 214 and/or the backend processing subsystem 216 may disable some of the ADCs 302A through 302N while enabling others of the ADCs 302A through 302N. In certain applications where the integrated electronic system 200 does not need to linearize OCT interference signals, the core processing subsystem 214 and/or the backend processing subsystem 216 may enable ADC 302A while disable ADCs 302B through 302N using the control signals 356. In some examples, the core processing subsystem 214 and/or the backend processing subsystem 216 may utilize control signal 370 to control the PLL 306 such that the PLL 306 generate control signals 362 to clock the ADCs 302A through 302N at different clock frequencies. As such, the digitized signals 354 generated by the ADCs 302A through 302N may correspond to lower or higher sample rates, depending on applications.

In some examples, the ADCs 302A through 302N may be controlled (e.g., using control signals 356) to record a-line trigger signal(s) or OCT tunable laser trigger signal. Advantageously, detecting the a-line trigger signal using the ADCs 302A through 302N may reduce jitter associated with the a-line trigger signal significantly, thereby allowing the integrated circuit 210 to support certain applications (e.g., applications that demand low jitter). In some examples, at least two of the ADCs 302A through 302N may share the same internal clock signal (e.g., being clocked by the same clock signal).

In some examples, the DACs 304A through 304N may be clocked by the control signals 364 generated by the PLL 306. The DACs 304A through 304N may receive control signals 366 from the core processing subsystem 214 and/or the backend processing subsystem 216, and convert the control signals 366 to analog signals 368. The analog signals 368 may be further processed by the filter and signal conditioning module 310 for controlling the peripherals 230. For example, the control signals 366 may be utilized to control a camera of the peripherals 230 to capture optical signals through a MEMS module of the peripherals 230. As another example, the control signals 366 may be utilized to activate a fan associated with the integrated circuit 210 to facilitate thermal protection (e.g., cooling) on the integrated circuit 210. As still another example, the control signals 366 may be utilized to facilitate various functionalities such as calibration on a laser module or a camera, or controlling motors used by the integrated electronic system 200 through the peripherals 230 as noted above, or directly through the Core Processing Subsystem 214, or Backend Processing Subsystem 216.

FIG. 4A illustrates an example block diagram of the core processing subsystem 214, according to various implementations of the present disclosure. As shown in FIG. 4A, the core processing subsystem 214 may include a neural network model 402, a reconstruction pipeline 404 that includes a neural network model 402, linearization circuit 420, and reconstruction circuit 490, an acquisition engine 406, and an arbitrary waveform generator 408. Additional example implementations of the reconstruction pipeline 404 will be illustrated in FIG. 4B.

In some examples, the neural network model 402 may include various layers, where each layer may include one or more nodes. The neural network model 402 may be trained using datasets including k-clock signals, raw interference signals, and corresponding linearized OCT interference signals as well as variations of the k-clock signals to achieve better performance on reconstruction. For example, amplitude and frequency variations of the k-clock signals may be used to train the neural network model 402. More specifically, the variations of the k-clock signals may include certain percentage (e.g., 1%, 3%, 5%, 10%, 15%, 20%, or the like) of frequency and/or amplitude variations of the k-clock signals from nominal values. Such variations may emanate from differences between various laser technologies, or simply between laser modes or laser sweeps. Most critical variations on the k-clock can be represented as fluctuations on the instantaneous frequency of the signal. A dataset that includes pairs of original k-clock signals and corresponding linearized interference signals may be prepared for training the neural network model 402. In some examples, the neural network model 402 may include input, hidden, and output layers. The input layer may take k-clock signals and the raw interference signal as inputs, while the output layer may generate reconstructed interference signals. In other examples, the neural network model 402 may be replaced by other types of machine learning models, artificial intelligence models, support vector machines, Bayesian networks, regression models, or the like.

In some examples, the neural network model 402 may be trained using a loss function, such as mean squared error, to quantify the disparity between predicted and actual linearized and/or reconstructed signals. Optimization techniques, such as gradient descent, are used to iteratively adjust the network's internal parameters for improved accuracy.

In some examples, the neural network model 402 may be trained using training data set that is generated based on certain mathematical functions. For example, to generate the training set, a point spread function (PSF) can be calculated based on performances associated with components of the integrated electronic system 200 and variations of the performances, such as variations associated with optical bandwidth, optical losses, data capture rate, artifacts, operating modes, penetration associated with the material or subject being images, and/or other parameters. Based on the point spread function, a data set of transform-limited PSF can be generated and utilized as training data set to train the neural network model 402.

Additionally, and/or optionally, the performance of the neural network model 402 may be validated using a separate validation dataset to ensure that the neural network model 402 generalizes to unseen data. This step helps in detecting overfitting and ensures the robustness of the neural network model 402. Advantageously, by preparing and training the neural network model 402 as described above, the neural network model 402 may generalize well to new or unseen OCT interference signals, and may make the integrated circuit 210 less sensitive to hardware variations. The neural network model 402 may also perform linearization efficiently by reducing the need for multiple FFT computations and high-order interpolations, and may capture complex relationships in the data to result in more accurate linearization.

It should be noted that, in other examples, the integrated circuit 210 may use other signal processing techniques or modules (e.g., a linearization circuit 420 rather than the neural network model 402) to generate linearized and/or reconstructed interference signals 450. The integrated circuit 210 may use the linearization and/or reconstruction circuit 420 or the neural network model 402 to generate linearized and/or reconstructed interference signals 450, depending on user selection. For example, the linearization circuit 420 may utilize k-clock signal for linearization. More specifically, a k-clock signal may be generated by laser electronics or a dedicated k-clock module to indicate each time when a swept source traverses a predetermined wavenumber increment within a scanning range. The linearization circuit 420 may identify features in a k-clock dataset, such as zero crossings, to provide reference points for linearization, and use high-order interpolations and up-sampling to achieve linearization. OCT interference signals may be resampled by the linearization circuit 420 based on uniformly spaced k-space grid to ensure data is uniformly distributed in k-space. The linearization circuit 420 may employ various numerical methods to resample the digitized interference signals 354A. This may involve capturing both the k-clock signals 354B and the digitized interference signals 354A, creating datasets for each, and then using algorithms to resample interference data to achieve uniform k-space distribution.

In some examples, the reconstruction circuit 490 may be embodied as arithmetic logics (e.g., adders, multipliers, dividers, multiplexers, registers, quantizers, other computational elements, or the like) that implement a data processing pipeline to perform operations including some or all of background noise removal, dispersion compensation, FFT, log scaling, and display-scaling. The reconstruction circuit 490 may reconstruct image data based on linearized interference signals 450 generated by the neural network model 402 or the linearization circuit 420. In some embodiments, the linearization circuit 420 may implement conventional linearization techniques to generate linearized interference signals 450.

In some examples, the acquisition engine 406 may be embodied as digital logics that can be utilized to implement timing control and/or synchronization, real-time feedback, real-time data acquisition, or other real-time control associated with the integrated electronic system 200.

In some examples, the arbitrary waveform generator 408 may be digital logics that can be utilized to generate various kinds of waveforms for controlling at least the peripherals 230. For example, the arbitrary waveform generator 408 may generate semi-triangular, semi-sawtooth waveforms, square waveforms, or other types of waveforms for controlling various components of the peripherals 230.

In operation, the neural network model 402 may receive digitized interference signals 354A from the ADCs 302A through 302N. The digitized interference signals 354A may be digital representations of OCT interference signals. The neural network model 402 may also receive k-clock signals 354B from the ADCs 302A through 302N. Based on the digitized interference signals 354A and the k-clock signals 354B, the neural network model 402 may generate linearized interference signals 450 that may be received by the reconstruction circuit 490. Based on the linearized interference signals 450, the reconstruction circuit 490 may generate or reconstruct image data 460 through operations including background noise removal, dispersion compensation, FFT, log scaling, display-scaling, or the like.

The acquisition engine 406 may receive the image data 460 and transmit the image data 460 to the backend processing subsystem 216 for displaying OCT images. As shown in FIG. 4A, the core processing subsystem 214 may utilize a normal speed path 430B or a high-speed path 430A for transmitting the image data 460 to the backend processing subsystem 216 and/or the image data interfaces 250. The high-speed path 430A may use PCIe interface for data transmission to reduce latency. For applications where latency is less critical, the acquisition engine 406 may utilize the normal speed path 430B to transmit the image data 460 for displaying.

In some examples, the acquisition engine 406 may establish a direct and low latency communication channel between the ADC/DAC 212 and the core processing subsystem 214, and/or between the peripherals 230 and the core processing subsystem 214. For example, the acquisition engine 406 may generate control signals 470 to facilitate high speed control on the ADC/DAC 212, the analog front end 240, and/or the peripherals 230. Because the acquisition engine 406 may operate at higher speeds, clock rates, and/or without the need of firmware intervention (e.g., compared with the backend processing subsystem 216), control on the ADC/DAC 212, the analog front end 240, and/or the peripherals 230 may be conducted in more real-time manner to timely respond to or adjust the integrated electronic system 200 to achieve better performance. Additionally, and/or optionally, the acquisition engine 406 may control the ADC/DAC 212, the analog front end 240, and/or the peripherals 230 based on settings or parameters received from the backend processing subsystem 216.

In some examples, the control signals 470 may be processed by the arbitrary waveform generator 408 to generate the control signals 366 for controlling the peripherals 230. For example, based on the control signals 470, the arbitrary waveform generator 408 may generate the control signals 366 that correspond to semi-triangular or semi-sawtooth waveforms to drive some (e.g., beam scanners) of the peripherals 230. In some examples, the arbitrary waveform generator 408 may be bypassed such that the control signals 470 may be directly used to control the peripherals 230.

Additionally, the acquisition engine 406 may generate the control signals 356 and/or the control signal 370 to reconfigure the ADC/DAC 212 and/or the analog front end 240, depending on applications the integrated electronic system 200 is used for. For example, the acquisition engine 406 may disable some of the ADCs 302A through 302N in the ADC/DAC 212 using the control signals 356 in applications where the integrated electronic system 200 does not need to linearize OCT interference signals. In other applications, the acquisition engine 406 may enable more channels in the ADC/DAC 212 (e.g., enabling all of the ADCs 302A through 302N) and/or increase sampling rates of the ADCs 302A through 302N.

In some examples, as shown in FIG. 4A, the acquisition engine 406 may transmit the image data 460, other data, or information to the I/O circuit 270. For example, the GPIO pins of the I/O circuit 270 may allow the acquisition engine 406 to transmit data or information to other parts of the integrated electronic system 200 to facilitate real-time data access.

FIG. 4B illustrates an example implementation of the reconstruction pipeline 404, according to various implementations of the present disclosure. As shown in FIG. 4B, the reconstruction pipeline 404 (e.g., chirp compensation 406B) may generate the linearized interference signal 450. The linearized interference signal 450 may be generated based on output (e.g., the digitized interference signals 354A and the k-clock signals 354B) from one of the ADCs 302A through 302N. Here, the digitized interference signal 354 is shown to be a 12 bits signal, and the output of the reconstruction pipeline 404 (e.g., the image data 460) has 8 bits.

As shown in FIG. 4B, the digitized interference signals 354A may go through various successive processing stages including background subtraction 402B, apodization 404B, chirp compensation 406B, dispersion compensation 408B, zero padding 410B, Fast-Fourier Transform (FFT) 412B, pseudo-random bit sequence (PRBS) 414B, log scaling 416B, and scaling and down-sampling 418B. In the reconstruction pipeline 404, bit length of data may be increased and/or decreased based on desired precision, computational complexity, and available hardware resources. In some embodiments, the chirp compensation 406B may be embodied as or implemented by the neural network model 402 and/or the linearization circuit 420 of FIG. 4A. In the example implementation of the reconstruction pipeline 404 shown in FIG. 4B, bit length of data is 16 bits during apodization 404B, chirp compensation 406B, dispersion compensation 408B, zero padding 410B, Fast-Fourier Transform (FFT) 412B, pseudo-random bit sequence (PRBS) 414B, and log scaling 416B. The bit length is truncated to 8 bits at the scaling and down-sampling 418B.

FIG. 4C illustrates an example block diagram of the core processing subsystem 214, according to various implementations of the present disclosure. As shown in FIG. 4C, the core processing subsystem 214 may include an inference engine 422 (e.g., an inference device), an acquisition engine 406, and an arbitrary waveform generator 408. Unless otherwise noted, the components of FIG. 4C can be the same as or generally similar to like-numbered components of FIG. 4A. In some embodiments, the inference engine 422 may be implemented or embodied as an integrated circuit (e.g., an application specific integrated circuit (ASIC), a processor chip, or the like). The inference engine 422 may perform the functionalities performed by the reconstruction pipeline 404 (e.g., including the network model 402, the linearization circuit 420, and/or the reconstruction circuit 490) to generate image data 460 based on digitized interference signals 354A and k-clock signals 354B. As shown in FIG. 4C, the inference engine 422 can process image data (e.g., perform further image analysis on the image data 460) that are transmitted on the high-speed path 430A and/or the normal speed path 430B, before further processing is done on the image data 460 by a host computer or post processing circuitry.

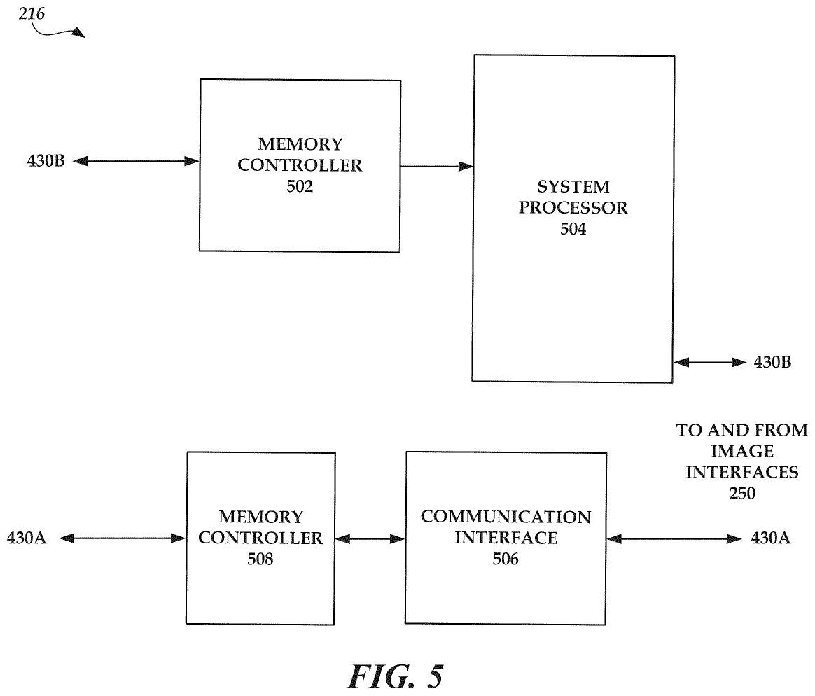

FIG. 5 illustrates an example block diagram of the backend processing subsystem 216, according to various implementations of the present disclosure. As shown in FIG. 5, the backend processing subsystem 216 includes a memory controller 502, a system processor 504, and a communication interface 506. As noted above, the backend processing subsystem 216 may include the normal speed path 430B and the high-speed path 430A for transmitting the image data 460 to the image data interfaces 250. The normal speed path 430B includes the memory controller 502 and the system processor 504. The high-speed path 430A includes the communication interface 506 and a memory controller 508.

In some examples, the system processor 504 may be embodied as any type of single-core, single-thread, multi-core, or multi-thread processor capable of performing functions as described herein. The system processor 504 may be embodied as a microprocessor, central processing unit (CPU), digital signal processor (DSP), microcontroller, or other processor or processing/controlling circuit. The system processor 504 may communicate with the image data interfaces 250, the ROM 260, and/or the memory 218 or the memory 220 to perform various functionalities for managing the integrated electronic system 200, such as system boot up (using the BIOS 262 inside the ROM 260), system shut down, file management, memory management, system calibration, system management (e.g., using a RTOS run on the memory 218 or the memory 220), and other functions. For example, the system processor 504 may provide the image data 460 to the image data interfaces 250 for displaying OCT images to the user devices 160, and/or passing the image data 460 to a host computer for display.

In some examples, the memory controller 502 may be embodied as circuitry or components to facilitate access of the memory 218 and/or the memory 220 by the acquisition engine 406 and/or the system processor 504. The memory controller 502 may also monitor access of the memory 218 and/or the memory 220, and trigger a system management interrupt (SMI) upon monitoring certain access events and/or request.

In some examples, the communication interface 506 may be embodied as circuitry, logics, or components to facilitate input/output operations associated with the acquisition engine 406 and/or the image data interfaces 250. For example, the communication interface 506 may be embodied as, or otherwise include, platform controller hubs, input/output control hubs, firmware devices, communication links such as bus links and printed circuit board traces, and other components that can facilitate input/output operations associated with acquisition engine 406, the image data interfaces 250, and/or other components (e.g., the GPU 280) of the integrated electronic system 200. In some examples, the communication interface 506 may be embodied as a Peripheral Component Interconnect Express (PCIe) interface, a Platform Controller Hub (PCH), or may implement the eXtensible Host Controller Interface (xHCI) specification to at least facilitate communications between the acquisition engine 406 and the image data interfaces 250.

In operation, the backend processing subsystem 216 may receive the image data 460 from the core processing subsystem 214. Depending on applications, the backend processing subsystem 216 may transmit the image data 460 to the image data interfaces 250 for display through the normal speed path 430B or the high-speed path 430A. As noted above, for applications where latency is critical, the backend processing subsystem 216 may transmit the image data 460 to the image data interfaces 250 through the high-speed path 430A (e.g., using the communication interface 506 and the memory controller 508). For applications where latency is less critical, the backend processing subsystem 216 may transmit the image data 460 to the image data interfaces 250 through the normal speed path 430B (e.g., using the memory controller 502 and the system processor 504).

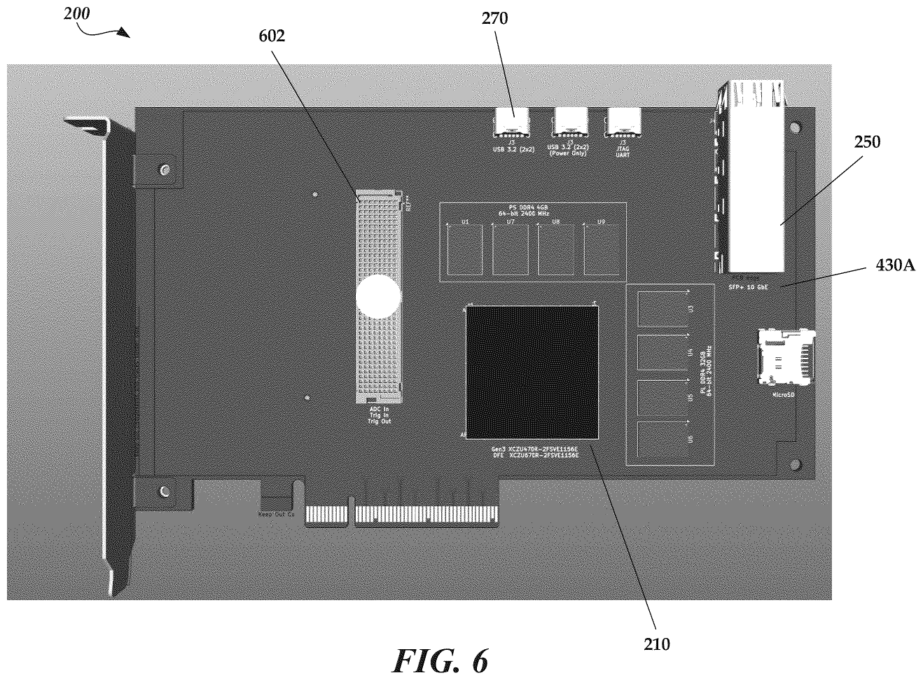

FIG. 6 illustrates an example integration of at least some portions of the integrated electronic system 200, according to various implementations of the present disclosure. As shown in FIG. 6, the integrated electronic system 200 may be embodied as a board (e.g., a PCB board) with various components installed on the board. For example, FIG. 6 shows at least the integrated circuit 210, the I/O circuit 270, a component 602 (e.g., a slot, a connector, or the like), the high-speed path 430A, and the image data interfaces 250 deployed on the board. The component 602 can facilitate transmission of OCT interference signals from a photodetector (not shown in FIG. 6) to the ADCs 302A through 302N of the integrated circuit 210. The image data interfaces 250 may include SFP+ module, e.g., an enhanced version of the Small Form-factor Pluggable (SFP) transceiver module The SFP+ module may provide compact, hot-pluggable network interface used for both data communications and provide high-speed connectivity. The image data interfaces 250 may also support 10 GbE (10 Gigabit Ethernet) standard to offer high speed data transfer. The image data interfaces 250 may also include a microSD (Secure Digital) card interface and/or module to facilitate data transmission with electronic devices such as smartphones, tablets, digital cameras, and other compact devices. The I/O circuit 270 can support USB 3.2 standard to offer significant improvements in data transfer speeds and functionality compared with predecessor standards. The integrated electronic system 200 can incorporate a PCI Express (PCIe) interface in the high-speed path 430A to achieve low-latency communication between the integrated circuit 210 and other components or expansion cards to enhance overall system performance and responsiveness.

### Example Waveforms and System Performance

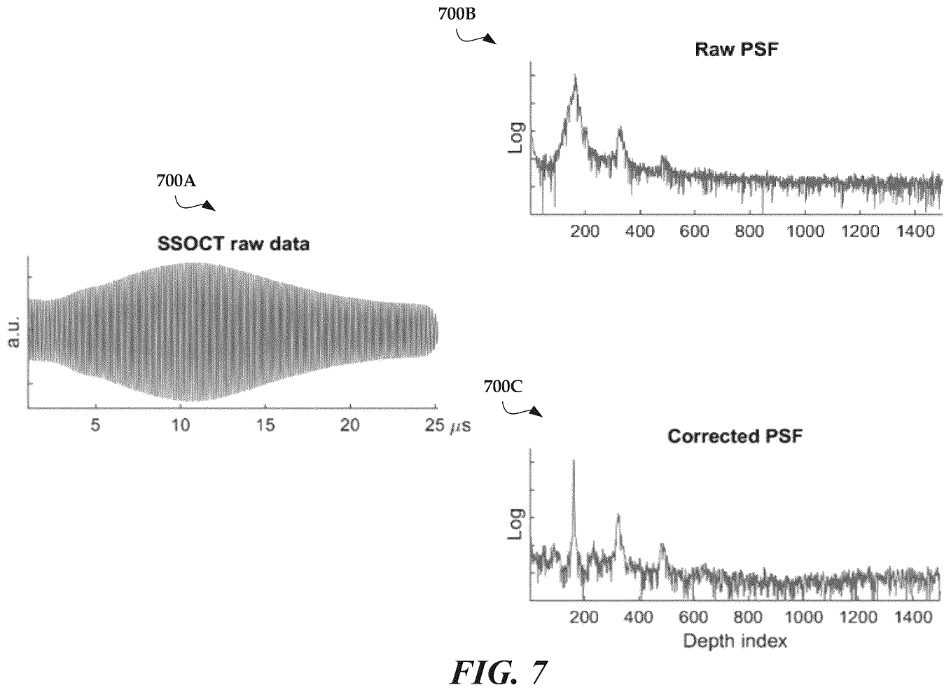

FIG. 7 illustrates example waveforms 700A, 700B, and 700C associated with the integrated electronic system 200 (e.g., ADC/DAC 212), according to various implementations of the present disclosure.

The waveform 700A shows a time domain waveform of the digitized interference signals 354A. The digitized interference signals 354A may be generated by the ADCs 302A through 302N through capturing and digitizing the electrical signals 350 (e.g., OCT interference signals) received from the peripherals 230 (e.g., an optical detector). In the waveform 700A, the digitized interference signals 354A may be generated by the ADCs 302A through 302N at a data rate of one GSPS.

The waveform 700B shows a frequency domain waveform on a logarithmic scale associated with the digitized interference signals 354A. More specifically, the waveform 700B can be generated using or applying a point spread function (PSF) on the digitized interference signals 354A.

The waveform 700C shows a frequency domain waveform on a logarithmic scale associated with signals generated or processed by the core processing subsystem 214. More specifically, the waveform 700C can be generated using or applying a point spread function (PSF) on an output of the reconstruction pipeline 404 (e.g., the image data 460). Compared with the waveform 700B, the waveform 700C shows improved spectral characteristics, such as improved signal to noise ratio (SNR). The improved spectral characteristics can be at least in part attributed to the linearization on the digitized interference signals 354A performed by the neural network model 402, and the various compensating functionalities performed by the reconstruction pipeline 404. Although not readily observed from the waveform 700C, the measured SNR can be over 80 dB, which satisfies the need for all ophthalmic OCT applications.

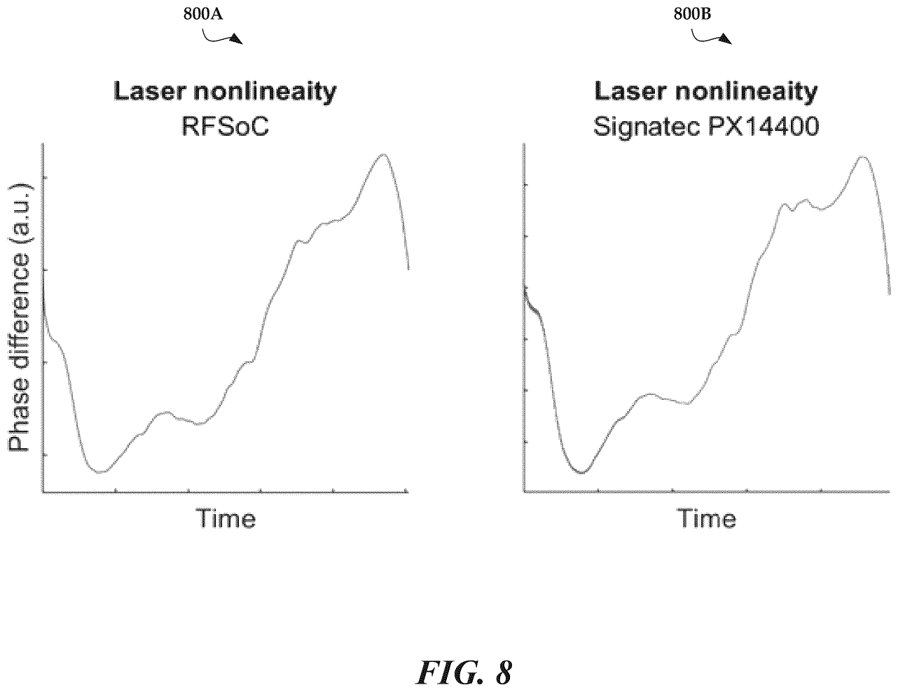

FIG. 8 illustrates an example waveform 800A and a benchmark waveform 800B, according to various implementations of the present disclosure. The waveform 800A illustrates laser nonlinearity associated with the integrated electronic system 200. The waveform 800B illustrates laser nonlinearity associated with a commercial OCT data acquisition card.

More specifically, the waveform 800A can be generated using phase information associated with the waveform 700A that shows a time domain waveform of the digitized interference signals 354A. The waveform 800B can be generated using data captured by the commercial OCT data acquisition card. Compared with each other, the waveforms 800A and 800B exhibit strong similarity. This demonstrates competitive performance accomplished by the integrated electronic system 200 under fewer discrete components (e.g., without the need of a discrete OCT data acquisition card).

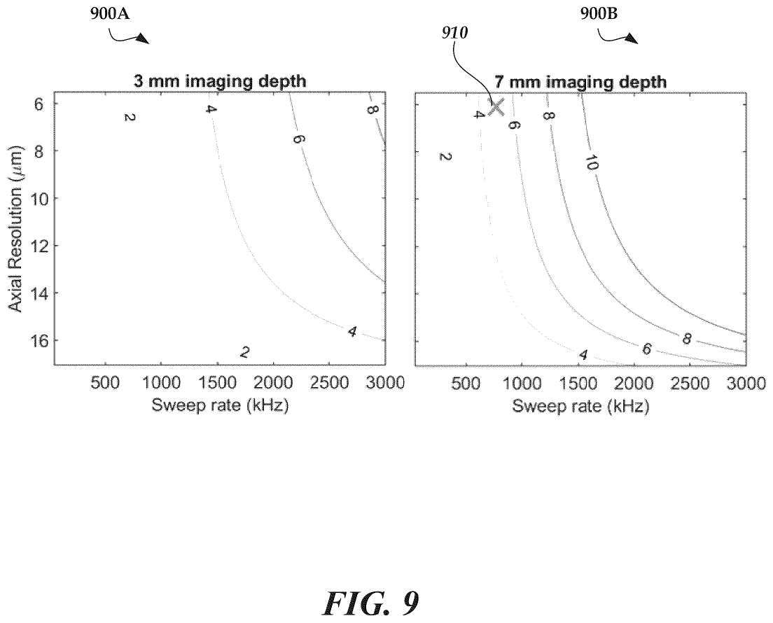

FIG. 9 shows example contour plots 900A and 900B illustrating requirements on the OCT system 100 for certain OCT applications. More specifically, FIG. 9 shows the high sampling rates or clock frequencies on the OCT electronics 120 and/or the integrated electronic system 200 for achieving desired sweep rates and axial resolutions.

The contour plot 900A shows the clock frequency requirement to meet desired sweep rates and axial resolutions under 3 millimeter (mm) imaging depth. The contour plot 900B shows the clock frequency requirement to meet desired sweep rates and axial resolutions under 7 mm imaging depth. The numbers (e.g., 2, 4, 6, 8, or 10) on the contours in the contour plot 900A and the contour plot 900B indicate the value of required clock frequencies to achieve desired sweep rates and axial resolutions.

In some examples, the cross mark 910 in the contour plot 900B represents the minimum performance required for intraoperative swept-source (SS) OCT related applications (e.g., 4D image capture). Compared with the OCT electronics 120 that utilize the plurality of components 120A-120D for processing electrical signals, the integrated electronic system 200 may advantageously operate under higher clock frequencies, higher signal bandwidth, and/or shorter latency through integrating various components or circuitry into the integrated circuit 210. As such, the integrated electronic system 200 provides a promising solution to breakthrough bottlenecks caused by limitations of the OCT electronics 120 for uses in certain applications.

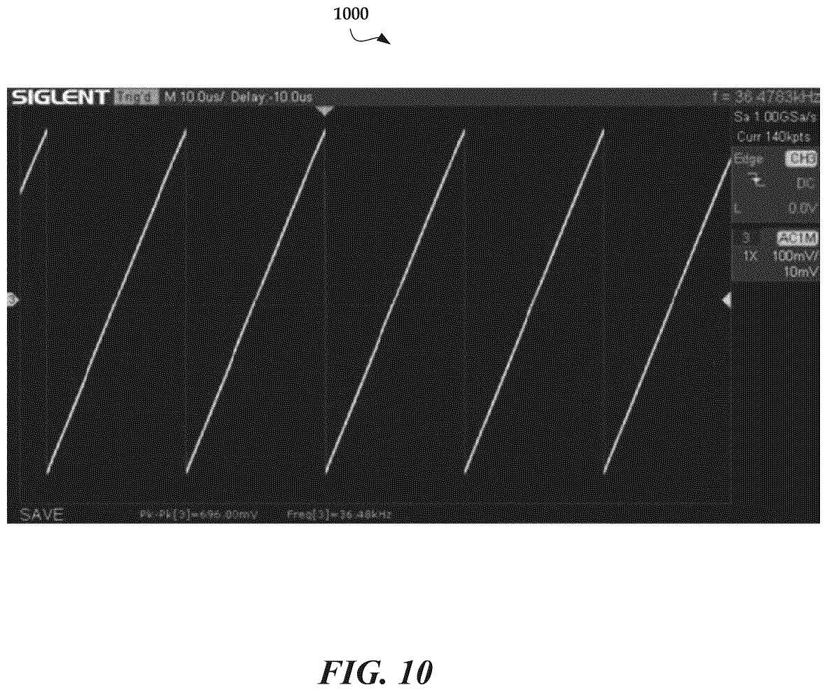

FIG. 10 illustrates example waveform 1000 associated with the arbitrary waveform generator 408, according to various implementations of the present disclosure. More specifically, the waveform 1000 illustrates a waveform of certain control signal 366 generated by the arbitrary waveform generator 408. As noted above, the waveform 1000 may be utilized to control some of the peripherals 230.

### CONCLUSION

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

It is to be understood that not necessarily all objects or advantages may be achieved in accordance with any particular example described herein. Thus, for example, those skilled in the art will recognize that some examples may be operated in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the example, some acts, events, or functions of any of the algorithms described herein can be performed in a different sequence, can be added, merged, or left out altogether (for example, not all described acts or events are necessary for the practice of the algorithms). Moreover, in some examples, acts or events can be performed concurrently, for example, through multi-threaded processing, interrupt processing, or multiple processors or processor cores, or on other parallel architectures, rather than sequentially. In addition, different tasks or processes can be performed by different machines and/or computing systems that can function together.

The various illustrative logical blocks and modules described in connection with the examples disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combination of the same, or the like. A processor can include electrical circuitry to process computer-executable instructions. In some examples, a processor includes an FPGA or other programmable device that performs logic operations without processing computer-executable instructions. A processor can also be implemented as a combination of computing devices, for example, a combination of a DSP and a microprocessor, a plurality of microprocessors, microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

The processes described herein or illustrated in the figures of the present disclosure may begin in response to an event, such as on a predetermined or dynamically determined schedule, on demand when initiated by a user or system administrator, or in response to some other event. When such processes are initiated, a set of executable program instructions stored on one or more non-transitory computer-readable media (e.g., hard drive, flash memory, removable media, etc.) may be loaded into memory (e.g., RAM) of a server or other computing device. The executable instructions may then be executed by a hardware based computer processor of the computing device. In some embodiments, such processes or portions thereof may be implemented on multiple computing devices and/or multiple processors, serially or in parallel.

Conditional language, such as, among others, “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, and/or the like may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain implementations require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general-purpose computer comprising one or more processors should not be interpreted as excluding other computer components, and may possibly include such components as memory, input/output devices, and/or network interfaces, among others.

While the above detailed description has shown, described, and pointed out novel features as applied to various implementations, it may be understood that various omissions, substitutions, and changes in the form and details of the devices or processes illustrated may be made without departing from the spirit of the disclosure. As may be recognized, certain implementations of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

What is claimed is:

1. An integrated electronic system for optical coherence tomography (OCT), the integrated electronic system comprising:
an integrated circuit (IC) configured to generate image data based on OCT signals for display, the IC comprising:
an analog circuit configured to receive and digitize the OCT signals to generate digitized signals;
a core processing subsystem configured to generate the image data based on the digitized signals; and
a backend processing subsystem configured to receive and cause the image data for display to a user.

2. The integrated electronic system of claim 1, wherein the core processing subsystem comprises a model or a linearization circuit configured to linearize the digitized signals to generate linearized interference signals.

3. The integrated electronic system of claim 2, wherein the model is a neural network model or a machine learning model that is trained using a dataset comprising a k-clock signal, linearized OCT interference signals, and variations of the k-clock signal.

4. The integrated electronic system of claim 2, wherein the core processing subsystem comprises a reconstruction pipeline configured to reconstruct the linearized interference signals to generate the image data using a reconstruction circuit or a NN.

5. The integrated electronic system of claim 1, wherein the backend processing subsystem comprises a first path and a second path that are configured to receive and cause the image data for display to the user, and wherein the first path has a lower latency compared to the second path.

6. The integrated electronic system of claim 1, wherein:
the analog circuit comprises a plurality of analog to digital converters (ADCs) configured to digitize the OCT signals to generate digitized signals; and
the core processing subsystem is configured to generate, depending on an application associated with the integrated electronic system, a control signal to reconfigure the plurality of ADCs.

7. The integrated electronic system of claim 6, further comprising a printed circuit board (PCB), wherein the IC and a plurality of peripheral components are deployed on the PCB.

8. The integrated electronic system of claim 7, wherein the core processing subsystem is configured to generate a plurality of control signals to control the plurality of peripheral components.

9. The integrated electronic system of claim 8, wherein the analog circuit comprises a plurality of digital to analog converters (DACs) configured to convert the plurality of control signals to a plurality of analog signals to control the plurality of peripheral components.

10. The integrated electronic system of claim 8, wherein at least two of the plurality of control signals is generated according to a single clock signal generated by the IC.

11. The integrated electronic system of claim 7, wherein the plurality of peripheral components comprise at least one optical sensor, at least one light source, a camera, at least one position sensor, at least one motor, or a beam-scanning assembly.

12. The integrated electronic system of claim 6, wherein at least one of the plurality of ADCs is used to sample or record an a-line trigger signal.

13. The integrated electronic system of claim 1, further comprising a graphics processing unit (GPU), and wherein the backend processing subsystem causes the image data to be transmitted to the GPU for processing and/or display to the user.

14. The integrated electronic system of claim 13, wherein the GPU is used as an inference device that is disposed within the IC or outside the IC.

15. A printed circuit assembly comprising:
an optical detector configured to:
receive one or more optical signals; and
generate OCT interference signals based at least on the one or more optical signals;
an integrated circuit (IC) configured to generate image data based on the OCT interference signals; and
an image data interface configured to:
receive the image data from the IC; and
transmit the image data to an external device for display to a user.

16. The printed circuit assembly of claim 15, wherein the image data interface is a Thunderbolt port, a DisplayPort connector, an OCuLink connector, a Universal Serial Bus (USB) port, a High-Definition Multimedia Interface (HDMI) port, an Ethernet connector, or a Peripheral Component Interconnect Express (PCIe) connector.

17. The printed circuit assembly of claim 15, wherein the IC comprises:
an analog circuit configured to receive and digitize the OCT interference signals to generate digitized interference signals;
a core processing subsystem configured to generate the image data based on the digitized interference signals; and
a backend processing subsystem configured to:
receive the image data from the core processing subsystem; and
transmit the image data to the image data interface.

18. The printed circuit assembly of claim 17, further comprising a plurality of peripheral components, and wherein the core processing subsystem is configured to control the plurality of peripheral components.

19. The printed circuit assembly of claim 15, wherein the external device is a laptop, a computer workstation, a discrete graphics card, or a mobile device.

20. The printed circuit assembly of claim 15, wherein the one or more optical signals comprise an interferometric OCT signal or an interferometric k-clock signal.

21. An integrated circuit (IC) comprising:
an analog circuit configured to receive and digitize OCT interference signals to generate digitized interference signals;
a core processing subsystem configured to generate image data based on the digitized interference signals; and
a backend processing subsystem configured to receive and cause the image data for display to a user.

22. The integrated circuit of claim 21, wherein the core processing subsystem comprises a model configured to process the digitized interference signals to generate processed interference signals, wherein the model is a neural network model or a machine learning model.

23. The integrated circuit of claim 21, wherein the backend processing subsystem comprises a first path and a second path that are configured to receive and transmit the image data to an image data interface, and wherein the first path has a lower latency compared to the second path.
